(19) United States
(12) Patent Application Publication
(10) Pub. No.: US 2006/0095290 A1
(43) Pub. Date: May 4, 2006

(54) System and method for authenticating users for secure mobile electronic gaming

(75) Inventor: Sergey Chernev, Moskow (RU)

Correspondence Address: COOPER & DUNHAM, LLP, 1185 AVENUE OF THE AMERICAS, NEW YORK, NY, 10036, US

(73) Assignee: KVARTS, LLC

(21) Appl. No.: 11/266,135

(22) Filed: Nov. 2, 2005

Related U.S. Application Data
(60) Provisional application No. 60/624,404, filed on Nov. 2, 2004.

(51) Int. Cl. G06Q 99/00

(52) U.S. Cl. 705/1

(57) ABSTRACT

A method for authenticating a wireless device on a secure network includes transmitting a first communication from the wireless device to the network. The first communication includes an application code selected according to a type of the wireless device. A second communication is transmitted from the network to the wireless device. The second communication includes an application or link thereto. The application is installed on the wireless device and the application is executed.

### REFERENCE TO RELATED APPLICATION

This application claims benefit of U.S. Provisional Application No. 60/624,404 filed Nov. 2, 2004, the entire contents of which are herein incorporated by reference.

### BACKGROUND

1. Technical Field

The present disclosure relates to electronic transactions and, more specifically, to authenticating users for secure mobile electronic transactions.

2. Description of the Related Art

Electronic transactions have become an increasingly important feature of modern commerce. Electronic transactions allow for the fast, convenient and reliable transfer of funds from a source to a destination. Businesses have developed a wide range of systems for implementing electronic transactions, for example over the internet. For example, traditional brick and mortar businesses such as merchants, banks, and casinos successfully offer their goods and services over the internet using electronic transactions. While electronic transactions offer unparalleled convenience, ensuring a secure operating environment is absolutely essential to the widespread adoption of electronic commerce. When electronic commerce occurs over the internet, for example using a web browser, protocols such as HTTPS may be used to provide a secure channel of communication between the user and the business, for example, the merchant, bank or casino.

Mobile electronic transactions are electronic transactions that occur over a mobile communications network, for example, a wireless GSM or CDMA network, a satellite communications network, a WiFi network or any other wireless communications system available to a user. Mobile electronic transactions may be implemented using a wireless device, for example, a mobile telephone, smartphone, PDA-phone and/or portable computer.

Conducting electronic transactions using mobile devices allows users a new level of convenience to conduct business and engage in recreational activities without having to be in front of a desktop computer. For example, a user may shop, pay bills, and engage in games of chance while on the move or enjoying free time.

Mobile electronic transactions require effective means for ensuring transaction security to prevent eavesdropping and/or fraud. Wireless service providers, for example, GSM and CDMA wireless telephone service providers utilize methods of securing wireless communications between wireless terminals and base stations and towers. However, businesses offering electronic transaction services generally do not have direct secure access to the base stations and towers. Such services are commonly accessed over the internet by a user with a web-enabled portable device. In such systems, even while the wireless provider may provide data security from the wireless device to the base station or tower, after this point, the transaction data may travel over the internet without the necessary security measures.

Unlike modern web browsers used on desktop personal computers, web browsers commonly found in mobile devices may utilized scaled down browsers such as wireless application protocol (WAP) browser to communicate over the internet. These scaled down browsers may lack the security protocols found in full-scale browsers that allow for secure communications. For example, a WAP browser found in a web-enabled GSM mobile telephone may be unable to utilize HTTPS protocols to form a secure communications link between the user and the merchant, bank or casino, for example, due to an absence of installed root certificates.

Current methods for implementing electronic gaming such as Russian Federation Patent No. RU 2,235,360 to Kryzhanovskii, relate to playing games of chance using a mobile telephone. In Kryzhanovskii, communications between the mobile device and the gamming center are kept to a minimum by only communicating gaming results at fixed intervals. In Kryzhanovskii, a series of games with a predetermined amount of overall winnings and/or losses is played, whereby at the end of each game, the overall winnings or losses are determined. This amount is compared to a predetermined sum, and if the overall running winnings or losses have reached a predetermined sum, the portable gaming device generates a signal containing information on the overall results from this series of games.

However, systems in the art, such as Kryzhanovskii, fail to disclose a method and system for authenticating users and establishing a secure communication, especially when the mobile device being used has not been pre-equipped with secure communications protocols such as HTTPS.

There is therefore a need for a method and system to authenticate users for secure mobile electronic transactions.

### SUMMARY

A method for authenticating a wireless device on a secure network for performing electronic gaming for pecuniary stakes includes transmitting a first communication from the wireless device to the network. The first communication includes an application code selected according to a type of the wireless device. A second communication is transmitted from the network to the wireless device. The second communication includes an application for performing electronic gaming for pecuniary stakes, or link thereto. The application is installed on the wireless device and the application is executed.

A system for authenticating a wireless device on a secure network for performing electronic gaming for pecuniary stakes includes a first-communication transmitting means for transmitting a first communication from the wireless device to the network. The first communication includes an application code selected according to a type of the wireless device. A second-communication transmitting means transmits a second communication from the network to the wireless device. The second communication includes an application for performing electronic gaming for pecuniary stakes, or link thereto. An installing means installs the application on the wireless device and an executing means executes the application.

A method for authenticating a wireless device on a secure network for performing electronic transactions other than gaming for pecuniary stakes includes transmitting a first communication from the wireless device to the network. The first communication includes an application code selected according to a type of the wireless device. A second communication is transmitted from the network to the wireless device. The second communication includes an application for performing electronic transactions other than gaming for pecuniary stakes, or link thereto. The application is installed on the wireless device and the application is executed.

A system for authenticating a wireless device on a secure network for performing electronic transactions other than gaming for pecuniary stakes includes a first-communication transmitting means for transmitting a first communication from the wireless device to the network. The first communication includes an application code selected according to a type of the wireless device. A second-communication transmitting means transmits a second communication from the network to the wireless device. The second communication includes an application for performing electronic transactions other than gaming for pecuniary stakes, or link thereto. An installing means installs the application on the wireless device and an executing means executes the application.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram showing a method and system for user registration according to embodiments of the present invention;

FIG. 2 is a diagram showing a method and system for user authentication according to embodiments of the present invention;

FIG. 3 is a diagram showing a method and system for user authentication according to embodiments of the present invention;

FIG. 4A is a scenario for initiating a given operation according to an embodiment of the present invention;

FIG. 4B is a scenario for initiating a given operation according to another embodiment of the present invention;

FIG. 4C is a scenario for initiating a given operation according to another embodiment of the present invention;

FIG. 5 is a diagram showing a method and system for downloading a mobile application according to embodiments of the present invention;

FIG. 6 is a diagram showing a method and system for upgrading the applications, for example the mobile gaming applications, according to embodiments of the present invention;

FIG. 7 is a diagram showing a method and system for authorization during the application process, for example, the gaming process according to embodiments of the present invention;

FIG. 8 is a diagram showing a method and system for logging onto the application web server, for example, the mobile gaming system web server, according to embodiments of the present invention;

FIG. 9 is a diagram showing a method and system for making financial transactions at the cash reception/payment office according to embodiments of the present invention; and

FIG. 10 is a diagram showing a method and system for restoring a user's account access according to embodiments of the present invention.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present invention provide systems and methods for authenticating users for secure electronic transactions, for example, wireless electronic transactions. In developing wireless communications applications for secure electronic transactions, it became necessary to create a reliable user-authorization system that would automate most operations related to the identification and account activity of system users and provide maximum convenience and transparency during use, while at the same time offering the required level of confidentiality and protection.

Embodiments of the present invention provide for communication between an application on the user's wireless terminal (for example, a wireless GSM telephone) and the application service provider's application server, using data transmission by GSM media, for example, and the Internet.

According to one embodiment of the present invention, the application service provider, for example a gamming institution offering online games of change, offers the end-user the opportunity to engage in games of chance from a wireless device over secure communications. The wireless device may be, for example, a web-enabled wireless telephone having a mobile browser, for example a WAP browser, and the ability to execute applications, for example Java applications, for example a J2ME Java application or an application for a mobile implementation of Java.

In such an embodiment, many potential users of the system may not want to provide sufficient information about them or make public their personal data or the amount of money passing through their accounts in the system. Embodiments of the present invention may therefore maximize anonymity while providing effective authentication and security. Moreover, in the event that the wireless device becomes lost or stolen, embodiments of the present invention may maintain the security and privacy of the user, while allowing for the quick and convenient authorization of a new mobile telephone on the system.

Simplifying the Registration Procedure for New Users in the System

Embodiments of the present invention allow for registration of new users in the system using a wireless device, for example, using only a mobile phone.

Protecting User Account Information and Equipment from Access by Third Parties in Case the Wireless Device is Lost or Stolen

Even though a wireless terminal is a device for individual use and, in general, provides protection against unauthorized use, modern technology in the field of microelectronics and hacking make it possible for malicious individuals to gain complete access to cell-phone memory if the phone is stolen. The limited system resources and capabilities of the device and the limited software available when developing programs for mobile phones do not allow a sufficient level of protection within the telephone.

Embodiments of the present invention minimize or eliminate the possibility of unauthorized access to a user's account and funds in his account, if malicious individuals should gain full access to the user's cell-phone memory.

Restoring Access to User Account after Change of Telephone, Change of Telephone Number, or Loss of Telephone

Embodiments of the present invention provide the possibility of restoring a user's access to the system in the event of theft, loss, or replacement of his wireless device, for example, wireless phone and/or telephone number.

Providing a Uniform Mechanism and Technology for User Access to Features of “Mobile Gaming System” Modules

Embodiments of the present invention provide a uniform mechanism for user access to the various e-commerce/banking/gaming and software modules and a procedure for installing new system modules with a minimum effort on the part of the user. For example, a mobile gaming system module may be easily acquired and installed on the user's wireless device, for example, mobile telephone. Easy installation of new modules, with a uniform mechanism for user identification with a familiar unified interface is provided.

Limiting Uncontrolled Spread of Mobile Applications

Many wireless devices such as mobile telephones permit the transmission of loaded applications among themselves, for example, many wireless devices are capable of sending an application loaded on one device to another device, for example, over using an infrared signal. In order to limit the uncontrolled spread of applications, embodiments of the present invention may utilize copy-protection schemes.

Applications loaded as embodiments of the present invention, for example, mobile gaming system modules, may be personalized for the specific user. These personalized applications may allow for access to the user's account. Embodiments of the present invention may block the copying of an application to another wireless device to prevent malicious individuals from gaining access to a phone and attempting to break into the user's account. This may be executed, for example, by preventing copying of an application and/or by limiting the running of the application to a particular wireless device and/or by preventing two copies of the same application from executing.

Positioning the Authorization System

Embodiments of the present invention may allow a user to carry out electronic transactions, for example, a complete set of operations in the “Mobile Gaming System,” using a wireless terminal, for example, a GSM standard or CDMA standard mobile telephone or an internet-connected personal computer, while providing the required level of confidentiality, anonymity, and security.

Authorization of User Identity

A number of parameters may be associated with each user in the system, some of which may be required. Parameters used for authorization and authentication of the user in the system may be required parameters. Parameters used in procedures for restoring a user's access in the event of loss or theft, if the memory in the telephone is destroyed, in case of a new telephone number, and to allow operation with the WEB resources of the “Mobile Gaming System” without the use of a mobile phone may be optional parameters.

Examples of Required Parameters May Include:

Unique user identifier (UID): The UID may be a number with a predetermined number of digits, for example 16 digits, for uniquely identifying a user on the system. The UID need not be directly displayed anywhere. It may be generated upon initial registration of the user. It may be written in the descriptors of applications loaded by the user and may be used for purposes of authorization. It may be generated by algorithms similar to GUID generation algorithms in the Windows operating system.

Personal code (password) of the user (PIN): The PIN may be an alpha-numeric code. The PIN may be a predetermined number of digits/characters. For example, the PIN may preferably be 4 digits/characters long, or more preferably 8 digits/characters long. The PIN may be entered and remembered by the user. The PIN need not be stored anywhere in the system or in the mobile applications and need not be sent to the server. It may be used to generate a UIDhash.

UIDhash: The UIDhash may be a hash identifier of the user, obtained with the PIN code, entered by the user. It is used for authentication of the user. The UIDhash may be stored on the server and need not be sent. The UIDhash may be used to check the hash code sent by the application running on the user's wireless device during authorization of the user.

Phone#: The Phone# may be the telephone number of the wireless device of the user. It may be unique within the system. The phone # may be used to identify previously registered users when repeated requests for registration are received. The number may be determined from information sent in by the user, for example, via text message such as SMS.

ASN: The application serial number (ASN) may be a unique serial number of the application. Each application loaded on the user's telephone may contain a unique serial number. It may be a decimal number, for example of no less than 16 digits. A list of serial numbers for loaded applications is associated with each user. The ASN may be generated during assembly of a personalized application loaded by the user. The algorithm for generating it is similar to GUID generation in the Windows operating system. Each loaded application may have a unique ASN. If the user reloads an application, then the old application is blocked. In this way, only one application of a given type can be associated with each user.

Examples of Optional Parameters May Include:

Password phrase: The password phrase may be a code word, for example, no less than 8 symbols long. The password phrase may be used for user authorization at the system site. The password phrase may be used along with the user's telephone number for restoring access.

Email: The user's email address may be used to notify the user of any updates in the applications, for example the “Mobile Gaming System”.

First and last name: The user's name and/or other personal information may be used to facilitate authentication.

Document#: The document# may be the serial number of an identification document used for verification purposes. For example, a passport number, driver's license number, or a military ID number. One or more of these document numbers may be used to verify identity of user during restoration of user access.

User Registration in the System

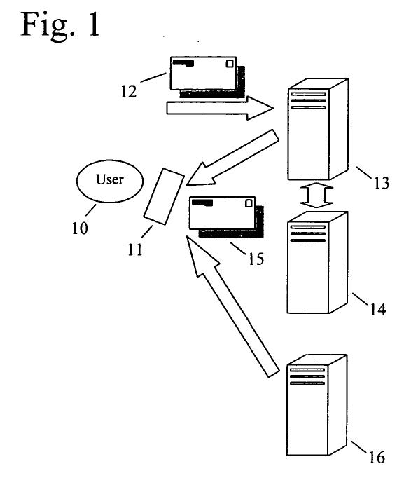

FIG. 1 is a diagram showing a method and system for user registration according to embodiments of the present invention.

To register in the system, the user 10 may use his wireless device to send a message, for example, an SMS message 12 to an SMS Gate server 13 for the purposes of transmitting an indicated registration number. The message may alternatively be an email or a telephone call. The registration number may be a telephone number or SMS address number that may be used to contact the system. The user 10 may obtain this number, for example, from the system's website, physical premises, advertising posters, brochures, etc. The message may contain an application code appropriate for the user's wireless device model, for example, mobile telephone model. This information may also be made available in the same manner as the registration number.

The SMS gate 13 may communicate with an account server 14 to verify the user's 10 registration. If the user 10 in question is not registered in the system (verified by telephone number), then the account server 14 may generate a new UID and send a link to the user's wireless device 11 to download a personalized application, for example, by SMS 15 (or email) via the SMS gate 13. Every mobile application, regardless of the type and model of phone, may contain a main menu item, allowing access to the user's account-management features. The user subsequently may use this function to carry out most operations involving his account.

The user 10 may follow a link indicated in the message sent by SMS 15, then download and install the mobile gaming application from a web server 16. The application downloaded by the user may be identified by the registered ASN and UID of the user.

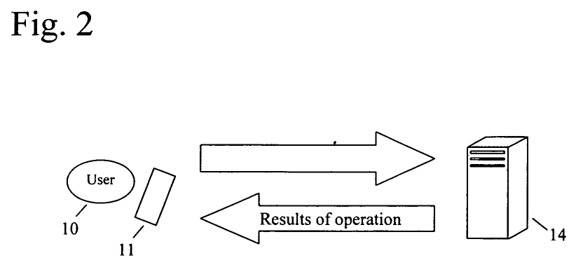

FIG. 2 is a diagram showing a method and system for user authentication according to embodiments of the present invention.

If the user 10 has not previously started installed applications from a given service, upon first startup of the installed gaming application, the application may prompt the user to set (change) his PIN for access. This procedure may be made mandatory. The user's PIN may have predetermined restrictions, for example, it may be required to be no less than 4 characters (maximum length 8 characters). To carry out this operation, the user 10 may be prompted to enter a new PIN two times to avoid error (this procedure may be standard for changing or initializing a password in information systems).

Once the PIN has been changed, the user 10 may be a fully registered participant in the transaction system, for example, the online store, online banking system or “Mobile Gaming System”.

An account administration menu item may be found in all mobile applications of the system, for example, the mobile gaming system (and may be implemented as a special link to a web server featuring special web sites catering to a mobile WAP browser). An account administration menu item may be implemented, for example, as a separate menu item or under other menu items in the application, such as “Options.” The account administration menu item may be used to carry out one or more of the following functions:

Changing PIN codes,

User-account operations: This function may used to deposit and withdraw money from the user's account at the system's payment locations,

Requests to upgrade gaming applications for mobile telephones, and

Receiving brief, one-time authorization keys for access to the system's WEB and WAP resources and other services.

All communications between the mobile gaming application and the system's application server may be made using a secure SSL protocol (HTTPS, WTLS) or a protocol of equivalent cryptographic security (for MIDP 1.0 devices and some MIDP 2.0 models that do not support the HTTPS protocol or erroneously implement that protocol, external RSA and IDEA encryption libraries are used).

These security protocols may be, for example, integrated into the application, for example, the mobile gaming system application and may be used even where the wireless device was not previously configured with such protocols.

User Authorization in the “Mobile Gaming System”

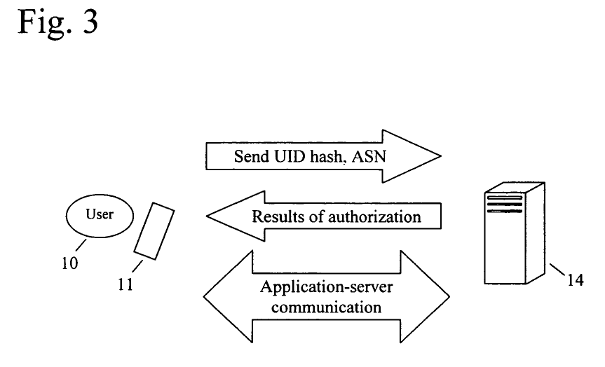

FIG. 3 is a diagram showing a method and system for user authentication according to embodiments of the present invention.

The user 10 may be required to go through the authorization procedure to carry out most actions in the application, for example the “Mobile Gaming System”.

The authorization procedure may comprise one or more of the following:

Application prompts for PIN,

UID hash may be generated based on the PIN and the UID registered in the application,

A secure link (RSA, IDEA, or HTTPS) may be established with the account server 14,

The mobile application may send an authorization request containing ASN and UID hash,

The account server 14 may identify the ASN and checks to see if it has been blocked. If the ASN has been blocked, the user may be sent a message asking him to download a new copy of the application,

The account server 14 may identify the user and check the UID hash, based on the ASN, and

If the UID hash matches, a positive authorization result may be sent.

When carrying out any operation, if the user enters an incorrect PIN, for example, three times (this may be checked at the server by comparing a stored UID hash value with a value calculated from the PIN and sent to the server), then his account may be blocked for a period of, for example, 24 hours (this period may be adjusted using the system's administrative interface). This mechanism is used to provide protection against unauthorized entry into a user's account by the direct method of trying PIN numbers, in case of a lost or stolen wireless, for example, mobile telephone.

Thus, access to user accounts may have several levels of protection:

| Level of protection | Function | Capabilities |
|---|---|---|
| HTTPS or link of | Protection against | Determined by algorithms |
| comparable capability | interception of traffic to | used in the protocol. |
| between mobile application | Internet by third parties for | Confirmed as global |
| and server | obtaining information on | standards |
| | user account | |
| Unique UID number | Identifies the user in the | It is a unique, |
| | system. Malicious intruder | pseudorandom number with |
| | must know the UID to | 16 decimal numbers. |
| | achieve successful | Possible combinations, 10¹⁶. |
| | authorization. UID may be | |
| | obtained by intruder only if | |
| | it is available to the user's | |
| | telephone memory, since | |
| | UID is not sent over open | |
| | channels. Hash function of | |
| | UID and PIN are used for | |
| | authorization. | |
| ASN (Application Serial | Serial number of the | Same as for UID. The |
| Number) | application. Used for | degree of security is |
| | identification of application | increased since the |
| | and user. It is a unique | application ASN can be |
| | number with 16 decimal | changed by downloading |
| | places. To achieve | new applications. If the user |
| | authorization, an intruder | loses his phone, he need |
| | must know the ASN of the | only download new copies |
| | application registered to the | of his applications on a new |
| | user. | phone, while the old phone |
| | | is blocked. |
| PIN code for user access | A string (typically of | Correctness of the entered |
| | numbers), 4 to 8 characters | PIN code is verified on the |
| | long. Used to calculate the | server. No more than 3 |
| | hash function from the UID | unsuccessful entry attempts |
| | for authorization on the | are allowed in a 24-hour |
| | server. | period. Even though the |
| | | number of possible |
| | | combinations is low (10⁴ in |
| | | the minimal case), it is |
| | | impossible in practice to use |
| | | them all, due to the three-try |
| | | limit imposed by the server |
| | | and the need to send the |
| | | application ASN at the time |
| | | of authorization. |

Obtaining Access Code by Service Number

To obtain a brief, one-time access code using a service identifier (Gate ID), the user may be required to do the following:

Find out the code of the required service (at the system WEB site, from advertising or distributed material, etc.),

Starts the primary application,

Selects one or more menu items,

For example, using dialog boxes, the user may be prompted to enter the service number (GateID), his PIN code (optional, depending on whether the PIN code was entered when the application was started), and the operation parameter, if the GateID includes such a parameter,

Depending on the type of service, the access code may be shown on the screen or may be sent by SMS (typically, only a URL for access to various types of resources and service can be sent by SMS, but not secret keys).

The user may then use the access code that is generated for authorization in the services of the “Mobile Gaming System” Project.

The access code (authorization) he receives may be linked to the particular user and may be a short-lived (several minutes) key of, for example, 8 to 12 characters. The time available for hacking into the service may be further limited by introducing an artificial delay of several hundred milliseconds at the server end during operations with the user access code.

Installing Mobile Gaming Applications

To download an application for electronic transactions, for example, a mobile gaming application, the user should first receive a link for carrying out the operation. The link may be sent to the user in an SMS message.

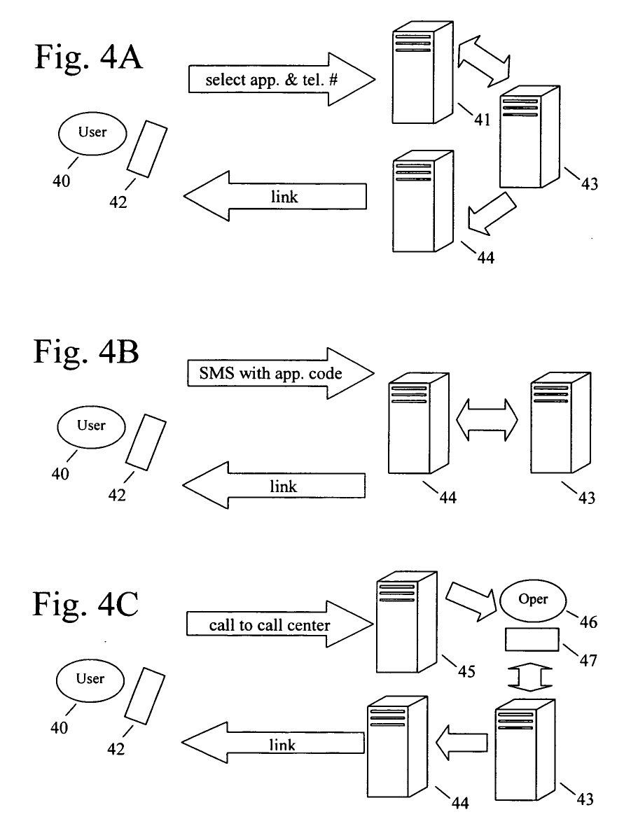

Various different scenarios may be used to initiate a given operation. For example, one of the three scenarios listed below may be used to initiate a given operation. According to the first example scenario illustrated in FIG. 4A, “Download using the system's public WEB site,” the following steps may be executed:

(1) The user 40 may access the system's public web site on the system's web server 41 via the user's wireless device 42,

(2) The user 40 may select the required mobile application and model of the user's wireless device 42,

(3) The user 40 may enter his telephone number, IP address, or MAC address and initiate the operation to receive a link for downloading the mobile operation,

(4) The web server 41 may processes the request, creating an account for the subscriber on an account server 43 if the user is a first-time user of the service (may be determined from his telephone number, IP address, or MAC address),

(5) The web server 41 may send a message containing a link for downloading the application to the user's wireless device 42 via the SMS gate server 44.

According to the second example scenario illustrated in FIG. 4B, “Download using a mobile device,” the following steps may be executed:

(1) The user 40 may determine the contact number of the system, for example, of the SMS gate server 44, and a download code of the required application, for example, from an advertisement or other source external to the system.

(2) The user 40 may send a message, for example an SMS message or email, with the application code at the service number he has selected to the contact number.

(3) The SMS gate server 44 may contact the account server 43 which may process the request, creating an account for the user 40 if he is a first-time user of the service, for example, as determined from his telephone number, IP address, or MAC address.

(4) The SMS gate server 44 may send a message, for example an SMS message, containing a link for downloading the application.

According to the third example scenario illustrated in FIG. 4C, “Downloading with the operator's help,” the following steps may be executed:

(1) The user 40 may call a customer-service number at a call center gateway 45 from his wireless device 42.

(2) The user 40 may be recognized in the system from the number from which he calls and, if necessary, an account may be created for him as a new user by an operator 46 using an operator's workstation 47.

(3) The operator 46 may determine the user's needs, including his wireless device's model and the application, for example, the gaming application the subscriber wishes to download.

(4) The operator 46 may use the operator's workstation 47 to initiate the process of sending the user's wireless device 42 a message, for example an SMS message, containing the URL for downloading the application.

(5) The account server 43 may processes the request and have the SMS gate server 44 send an SMS message with a link for the user to download the application

Downloading a Mobile Application

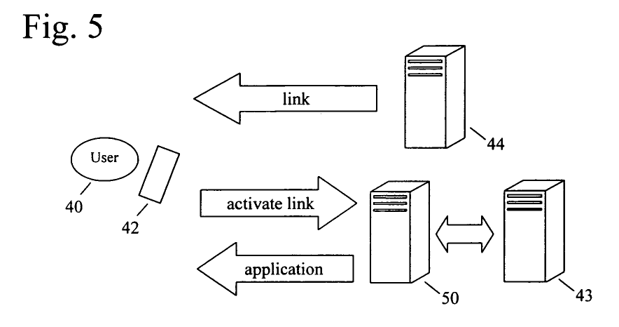

FIG. 5 is a diagram showing a method and system for downloading a mobile application according to embodiments of the present invention.

After receiving the link for downloading the mobile application, the user activates the link on his wireless device 42. This may activate the built-in WAP and/or WEB browser and the system's WAP/WEB server 50 is accessed.

Using an operation code registered in the URL link that was sent, the system WAP server 50 communicates with the account server 43 to retrieve information on the request to download the application, prepare the application (for example by assembling and signing a Midlet of the selected application), assign an ASN to the new application, and block all old applications of the same type.

As a result, the user may download and install the application on his wireless device.

Upgrading Mobile Gaming Applications

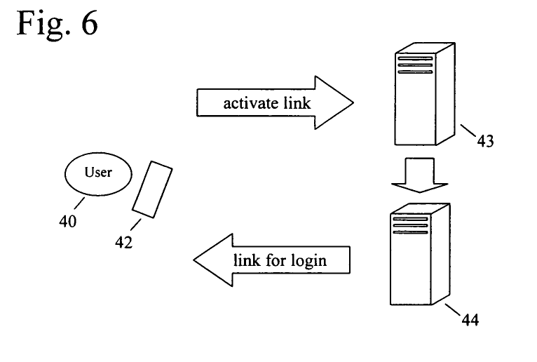

FIG. 6 is a diagram showing a method and system for upgrading the applications, for example the mobile gaming applications, according to embodiments of the present invention.

To upgrade gaming applications, the user may start the mobile gaming application and, after authorization, select a menu item to upgrade the application.

After the request arrives, the account server 43 may determine the type of application and the model of the wireless device 42 from the ASN of the application from which the request came.

If there are any upgrades for the wireless device model and application type in question installed on the server, the operation of downloading a new copy of an upgraded application is registered and the user may be sent an SMS message with a download code. The application may then be downloaded by the procedure set forth above entitled “Downloading a mobile application.”

Authorization During the Gaming Process

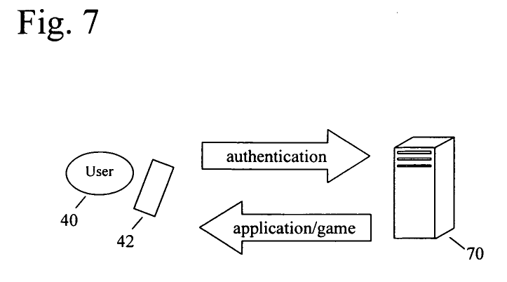

FIG. 7 is a diagram showing a method and system for authorization during the application process, for example, the gaming process according to embodiments of the present invention.

After starting the application, for example the gaming application, the user may enter his PIN code. The application may send the UID hash value, calculated from the UID and PIN, to the application server, for example, the game server 70.

If the calculated UID hash value matches, the user may be authorized on the game server 70 and a user session may be initiated.

Logging onto the “Mobile Gaming System” WEB Server

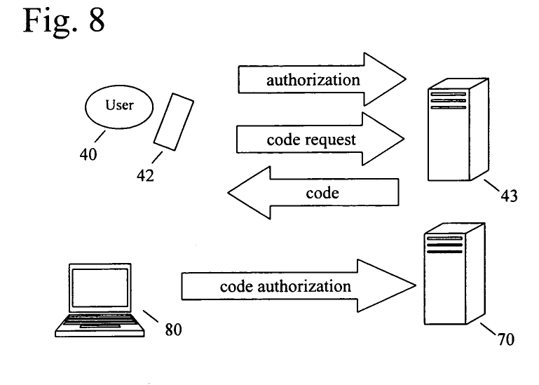

FIG. 8 is a diagram showing a method and system for logging onto the application web server, for example, the mobile gaming system web server, according to embodiments of the present invention.

To log onto the application server, for example the WEB server of the “Mobile Gaming System”, the user may generate an authorization key using his mobile application, for example the mobile gaming application, installed on his wireless device, for example, mobile telephone.

After the application starts up, the user may select the desired menu item, enter the GateID for logging onto the server (found on the authorization page on the web server), and send a request to receive an authorization code.

The system authorization server may prepare the operation and returns the code for conducting it to the application on the user's wireless device.

The user may enter the code he has received in the field for entering the authorization code on the WEB server. The WEB server may verify the code that has been entered, retrieve information on the subscriber, and initiate a session with personalized access to the server.

The user 40 may additionally/alternatively use the received code to access the game server 70 from the user's personal computer 80.

Making Financial Transactions at the Cash Reception/Payment Office

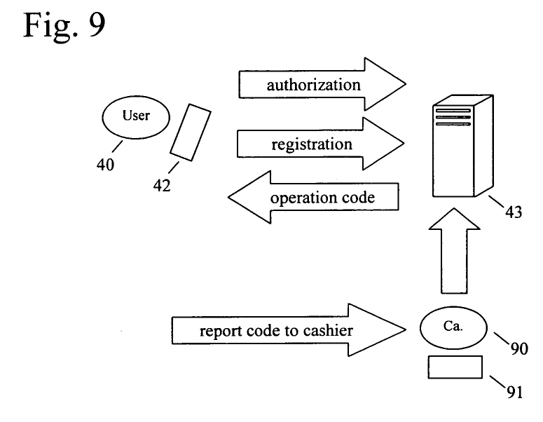

FIG. 9 is a diagram showing a method and system for making financial transactions at the cash reception/payment office according to embodiments of the present invention.

The user 40 may start the mobile application and authorized himself on the account server 43 by using his PIN code.

The user 40 may then selects the desired menu item and makes his request, entering the GateID corresponding to the operation (depositing money into or taking money out of his account at the respective cash reception/payment office).

The user may enter the required sum as a request parameter.

The system may process the request and prepares the operation on the server. The user may be given the code for carrying out the operation.

The user may reports the code to the cashier 90, who enters the operation code at the cash terminal interface 91.

Based on the operation code, the financial system may produce all the information on the operation (including the sum and the direction of the operation).

The cashier 90 may pay out/receive the money and confirms completion of the operation on the account server 43. The account server 43 may then store the operation code, the direction of payment, the amount of payment, and the identification number of the service center.

The user 40 may write an anonymous receipt containing, for example, no less than 20 characters, for indicating receipt of the indicated amount. The receipt may be kept by the cashier 90 for possible examination by a handwriting expert in case of dispute.

Access to the WAP Server of the “Mobile Gaming System”

For access to the WAP server of the mobile gaming system, gaming service, merchant, or banking institution, the subscriber may send a text message, for example, an SMS message to the number of the respective service.

Once the message has been received, the system may identify the user from his telephone number and prepare information on the user (if the user is a first-time user of the service, then a new user account may be created in the system).

In response to the message, the user may be sent an SMS message containing a URL for access to the system, in which an access code for the operation is encoded.

After the connection is activated using the telephone's WAP browser, the server determines the user's UID identifier from the operation access code.

Communication with the user may be accomplished using the HTTPS/WTLS protocols. If the user's wireless device, for example, mobile telephone, does not support WAP communication using secure protocols, then this scenario may be utilized for providing secure communications between the user and the server.

Once a secure connection has been made, the system may request the subscriber's PIN code (if the user is a first-time user of the service, then the system may prompt the user to initialize his PIN code by entering it twice).

Once the PIN code has been received at the server end, the hash function may be calculated from the UID (which may be stored on the server) and the user may be authorized on the system. If the PIN code is repeatedly entered incorrectly, then the user's account is blocked in the system.

The application for conducting mobile electronic transactions may be implemented via a mobile-optimized web site, for example a WAP site, rather than as a free-standing application, for example, a Java application. In either event, the same range of operations may be available to the user.

Restoring a User's Account Access

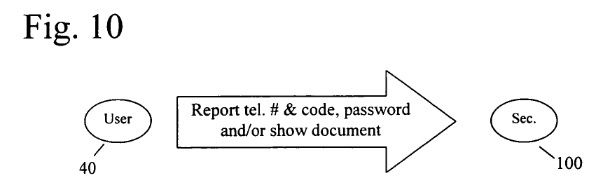

FIG. 10 is a diagram showing a method and system for restoring a user's account access according to embodiments of the present invention.

*If data have been erased from the wireless device then the registration
procedure may be repeated
*If the telephone number has been changed or the PIN has been
forgotten, the user may be referred to the security service 100
*The account may be blocked (in case of loss)
*PIN code may be changed if the PIN is forgotten
*The account may be registered again under a new telephone
number (if user changes telephones)

| Reason for loss of | |
|---|---|
| access to user account | Method of restoring access |
| User buys new wireless | 1. The user may be required to send an |
| device/telephone model | SMS to the registration number (see User |
| | registration in the system) with the new |
| | telephone (for example, after installing the |
| | old SIM card in the new wireless device |
| | when the wireless device is a GSM mobile |
| | device). |
| | 2. After receiving a link, the user may |
| | download a new version of the |
| | personalized application. In this case, the |
| | user need not change his PIN code. |
| | 3. The may be required to reinstall his |
| | personalized gaming applications. The old |
| | applications will automatically be blocked. |
| | 4. It is strongly recommended that loaded |
| | applications be removed from the memory |
| | of the old telephone before selling it or |
| | giving it to another person. |
| User changes | 1. User may be required to go through |
| telephone number | authorization on the WEB server, for |
| | example, the “Mobile Gaming System” |
| | using the old wireless device/mobile |
| | telephone and change the phone number |
| | under a menu option, for example a |
| | “Personal Options” option. |
| | 2. Alternatively, after changing the |
| | telephone number, the user may be |
| | required to call the User Support Services |
| | of the “Mobile Gaming System” and |
| | change the telephone number on his |
| | account through the operator, providing the |
| | data used to restore access (document, the |
| | number of which is indicated in the user's |
| | Personal Options or use a specialized |
| | console for access to his account at the |
| | Customer Services Office of the “Mobile |
| | Gaming System”. |
| Wireless device | The user may be required to turn to User |
| is lost or stolen | Support Services to have his account |
| | electronically blocked (to avoid access by |
| | third parties). In this case, the user must |
| | give the operator a code password and/or |
| | document number. |
| | An alternative method is access to his |
| | account from the system office, using a |
| | terminal that allows authorization using his |
| | telephone number and PIN code. |

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A method for authenticating a wireless device on a secure network for performing electronic gaming for pecuniary stakes, comprising:
transmitting a first communication from the wireless device to the network, the first communication comprising an application code selected according to a type of the wireless device;
transmitting a second communication from the network to the wireless device, the second communication including an application for performing electronic gaming for pecuniary stakes, or link thereto;
installing the application on the wireless device; and
executing the application.

2. The method of claim 1, wherein the wireless device is a mobile telephone.

3. The method of claim 1, wherein the first communication comprises a telephone number of wireless device.

4-8. (canceled)

9. The method of claim 1, wherein the application is personalized to the wireless device or a user of the wireless device.

10. The method of claim 1, wherein the application includes an application serial number (ASN) unique to the application sent to the wireless device.

11. The method of claim 1, wherein an account server on the network verifies the registration of a user of the wireless device and generates a new user identification number (UID) when the user is not registered on the network.

12. The method of claim 1, wherein the application provides secure access to a WEB or WAP site.

13. The method of claim 1, wherein the application is a Java application.

14. The method of claim 1, wherein the application communicates with the network using a secure SSL protocol, HTTPS protocol, WTLS protocol, protocol with cryptographic security, external RSA encryption libraries, and/or external IDEA encryption libraries.

15. The method of claim 1, wherein the first time the application is executed, a user is required to select a personal identification number (PIN).

16. The method of claim 1, wherein when the application is executed an authorization procedure is implemented.

17. The method of claim 20, wherein the authorization procedure comprises:
verifying a personal identification number (PIN);
generating a user identification number (UID) hash based on the PIN and a user identification number (UID) registered in the application;
establishing a secure link with the network;
sending an authorization request containing an application serial number (ASN) and the UID hash;
checking whether the ASN has been blocked and where the ASN has been blocked, sending a message to the user to download a new copy of the application; and
identifying the user based on the UID hash and ASN.

18. The method of claim 1, wherein the access code may be sent from the network to the wireless device for accessing various types of resources.

19. The method of claim 18, wherein the access code may be short lived.

20. The method of claim 1, additionally comprising transacting funds from a user account comprising:
selecting an application menu item for depositing or withdrawing funds from the user account;
processing the transaction on the network and a transaction code is given to the user for carrying out the transaction;
presenting the transaction code, from the user, to a cashier; and
completing the transaction by the cashier either accepting or issuing funds.

21. The method of claim 20, wherein transacting funds from a user account additionally comprises the user providing a hand-written receipt to the cashier that is used to verify the user's identity by handwriting when a dispute occurs.

22. The method of claim 1, wherein when the wireless device is lost or stolen, account access may be restored.

23. The method of claim 1, wherein when the PIN is forgotten, account access may be restored.

24. The method of claim 23, wherein account access may be restored by sending a third message to the network from a replacement wireless device; receiving a link to a new version of the application; installing the new version of the application; and executing the new version of the application.

25. A system for authenticating a wireless device on a secure network for performing electronic gaming for pecuniary stakes, comprising:
a first-communication transmitting means for transmitting a first communication from the wireless device to the network, the first communication comprising an application code selected according to a type of the wireless device;
a second-communication transmitting means for transmitting a second communication from the network to the wireless device, the second communication including an application for performing electronic gaming for pecuniary stakes, or link thereto;
an installing means for installing the application on the wireless device; and
an executing means for executing the application.

26-48. (canceled)
